(19) United States
(12) Patent Application Publication
(10) Pub. No.: US 2004/0174649 A1
(43) Pub. Date: Sep. 9, 2004

(54) Power supply device having overvoltage preventing function

(75) Inventor: Masahiko Ito, Anjo-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/784,199

(22) Filed: Feb. 24, 2004

(30) Foreign Application Priority Data
Mar. 5, 2003 (JP) 2003-58889

(51) Int. Cl. H02M 3/18

(52) U.S. Cl. 361/91.1

(57) ABSTRACT

A power supply device supplies electrical power to an electrical circuit that has to be protected from overvoltage. A protecting switch is disposed in a circuit connecting a power source, such as a battery, to the electrical circuit, such as a circuit for igniting an airbag system mounted on a vehicle. The power source voltage is compared with a reference voltage, and a control signal for turning off the protecting switch is generated when the power source voltage exceeds the reference voltage. The electrical circuit is disconnected from the power source, and thereby the electrical circuit is protected from overvoltage.

### CROSS-REFERENCE TO RELATED APPLICATION

This application is based upon and claims benefit of priority of Japanese Patent Application No. 2003-58889 filed on Mar. 5, 2003, the content of which is incorporated herein by reference.

### BACKGROUND OF THE INVENTION

1. Field of the Invention

The present invention relates to a device for supplying power to an electrical circuit, the device including a function for preventing overvoltage from being supplied to the electrical circuit. The present invention also relates to an airbag system mounted on an automotive vehicle, the system being powered by the power supply device of the present invention.

2. Description of Related Art

In most of electrical circuits including computers, a maximum voltage that can be imposed thereon is predetermined. When a voltage exceeding the maximum voltage (overvoltage) is imposed on the electrical circuit, the electrical circuit may be severely damaged. In case of a commercial power source, such overvoltage may be caused by a thunderbolt or other troubles in a power transmission line. In case of an automobile powered by a battery, the overvoltage may be supplied to the electrical circuits when battery terminals are disconnected, a headlamp filament is damaged, or an alternator voltage instantaneously increases due to a sudden change in loads, for example. These situations causing an instantaneous high voltage are referred to as load-dump.

In conventional electrical circuits or devices, circuit elements having a higher voltage-durability than usually required are used to cope with an unexpected overvoltage. However, such circuit elements make the device not only expensive but also bulky in size.

### SUMMARY OF THE INVENTION

The present invention has been made in view of the above-mentioned problem, and an object of the present invention is to provide a power supply device which protects an electrical circuit from an overvoltage. Another object of the present invention is to provide an airbag system mounted on an automotive vehicle, the airbag system being powered by the power supply device of the present invention.

An electrical circuit that has to be protected from overvoltage is powered by the power supply device according to the present invention. The power supply device includes a power source such as a battery, a voltage comparator and a protecting switch. The voltage comparator compares the power source voltage with a predetermined reference voltage, and outputs a control signal when the power source voltage becomes higher than the reference voltage. The protecting switch is turned off upon receiving the control signal from the voltage comparator.

The power source voltage may be boosted by a voltage booster disposed between the power source and the electrical circuit. The protecting switch is disposed in a circuit connecting the power source and the electrical circuit. For example, it is disposed before or after the voltage booster, or in the voltage booster. The power supply device of the present invention effectively protects the electrical circuit from the overvoltage without using circuit elements having unnecessarily high voltage-durability in the electrical circuit.

The power supply device of the present invention is advantageously applicable to an airbag system mounted on an automotive vehicle. The airbag system includes an airbag to be inflated with gas upon detection of an accidental collision and a device for generating the gas. The gas generating device is ignited by an igniter circuit to which electrical power is supplied from the power supply device of the present invention. The igniter circuit can be properly protected from the overvoltage.

Other objects and features of the present invention will become more readily apparent from a better understanding of the preferred embodiments described below with reference to the following drawings.

### BRIEF DESCRIPTION OF THE DRAWINGS

FIG. 1 is a block diagram showing an airbag system which is powered by a power supply device of the present invention;

FIG. 2 is a circuit diagram showing a power supply device as a first embodiment of the present invention;

FIG. 3 is a circuit diagram showing a power supply device as a second embodiment of the present invention;

FIG. 4 is a circuit diagram showing a power supply device as a third embodiment of the present invention; and

FIG. 5 is a circuit diagram showing a power supply device as a fourth embodiment of the present invention.

### DETAILED DESCRIPTION OF THE PREFERRED EMBODIMENTS

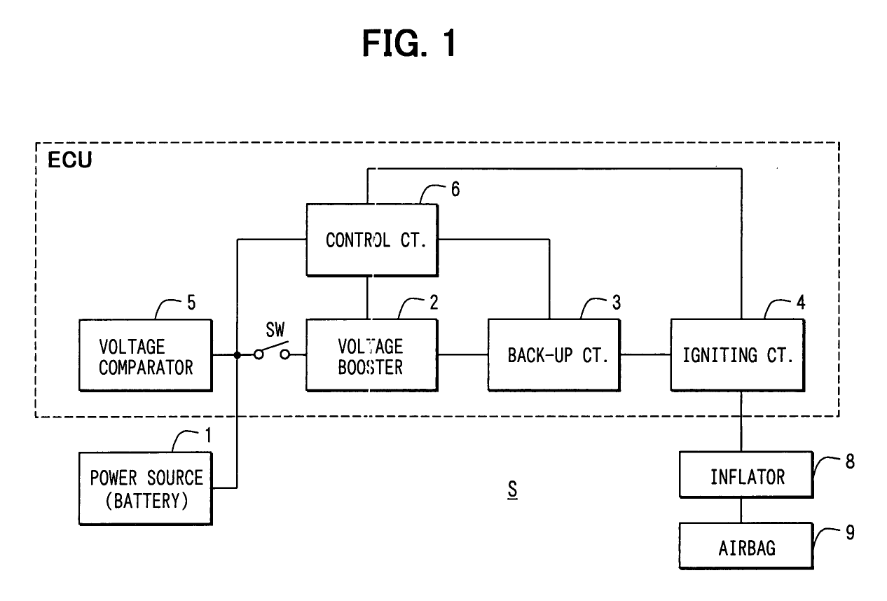

An airbag system powered by a power supply device according to the present invention will be described with reference to FIG. 1. The power supply device of the present invention is applicable not only to the airbag system but to other electrical circuits that have to be protected from an overvoltage.

The airbag system is mounted on an automotive vehicle for protecting a passenger from a high impact force otherwise imposed on the passenger at an automotive accident. The airbag system S is composed of a power source 1 (an on-board battery), an airbag 9, an inflator 8 for inflating the airbag 9 and an electronic control unit (ECU) for igniting a squib of the inflator 8 in a controlled manner.

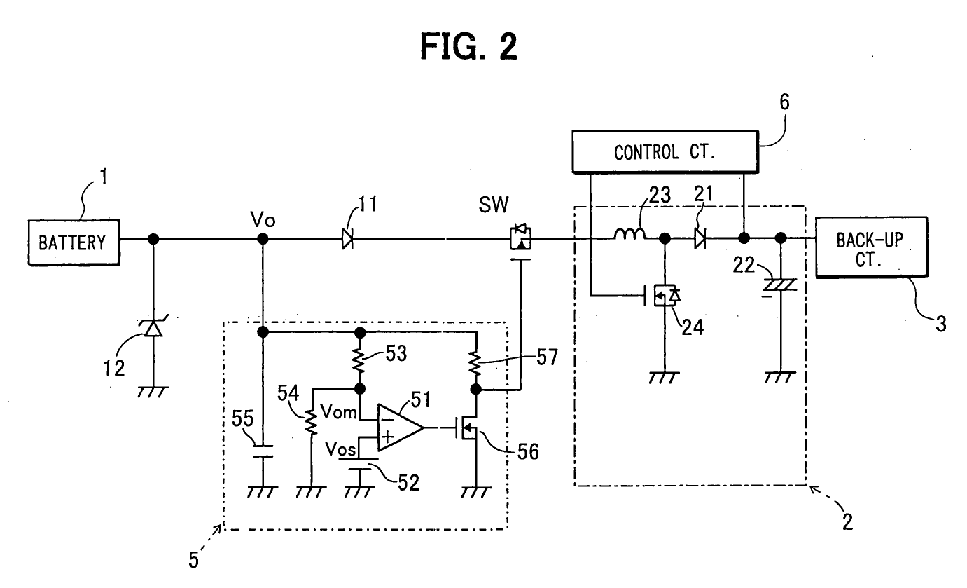

The electronic control unit (ECU) includes: a voltage booster 2 that boosts a voltage supplied from the battery 1; a back-up circuit 3 serving as a back-up power source, the back-up circuit 3 including a capacitor to which the voltage boosted by the voltage booster 2 is supplied; an igniting circuit 4 for igniting the squib of the inflator 8, a voltage being supplied thereto from the back-up circuit 3; a voltage comparator 5 for detecting the power source voltage and comparing the power source voltage with a reference voltage; a protecting switch SW that is controlled in an ON-OFF fashion by an output of the comparator 5; and a control circuit 6 for controlling the booster 2 and the igniting circuit 4. A power supply device including the battery 1, the voltage comparator 5, the protecting switch SW, the voltage booster 2, the back-up circuit 3 and the control circuit 6 will be described with reference to FIGS. 2-5.

A power supply device as a first embodiment of the present invention is shown in FIG. 2. The back-up circuit 3 and the control circuit 6 are known circuits. The voltage booster 2 and the voltage comparator 5 will be described in detail. The voltage booster 2 is composed of a rectifying diode 21, a smoothing capacitor 22, a booster coil 23 and a booster switch 24 that switches current flowing through the booster coil 23 at a high speed. Upon turning on an ignition switch (a key-switch) of the vehicle, the power source voltage (battery voltage) Vo is supplied to the voltage booster 2. The supplied power source voltage Vo (e.g., 12-14 volts) is boosted to a predetermined voltage level (e.g., 23 volts) by switching the booster switch 24 at a high speed. The control circuit 6 controls the switching operation of the booster switch 24 while watching an output voltage of the voltage booster 2.

The voltage comparator 5 is composed of: divider resistors 53, 54 for dividing the power source voltage Vo at a desired ratio; a comparator 51 for comparing the divided voltage Vom with a reference voltage Vos; a series circuit composed of a transistor 56 and a pull-up resistor 57 for converting outputs from the comparator 51 into signals for driving the protecting switch SW; a reference voltage source 52 for giving the reference voltage Vos; and a smoothing capacitor 55. The protecting switch SW composed of an FET (field effect transistor) is connected between the power source 1 and the voltage booster. A rectifying diode 11 is disposed between the power source 1 and the protecting switch SW.

The protecting switch SW is turned on or off in the following manner. When the power source voltage Vo is in a normal range, the divided voltage Vom is lower than the reference voltage Vos, and the comparator 51 outputs a positive signal with which the transistor 56 is turned on. The protecting switch SW is kept turned on. On the other hand, when the power source voltage Vo exceeds a predetermined level due to load-dump or any other reasons, the divided voltage Vom becomes higher than the reference voltage Vos. The comparator 51 outputs a negative signal or a ground level signal with which the transistor 56 is turned off. Upon turning off the transistor 56, the protecting switch SW is turned off, and the voltage booster 2 is cut out from the power source 1. Thus, the electrical circuit, such as the igniting circuit 4, connected to the voltage booster 2 is protected from the overvoltage.

A Zener diode 12 is connected to the power source 1, as shown in FIG. 2, so that an extraordinary high voltage exceeding the Zener voltage is not supplied to the voltage comparator 5. The voltage comparator 5 is protected from the extraordinary high voltage in this manner. The predetermined voltage level at which the protecting switch SW is switched from ON to OFF or OFF to ON can be arbitrarily set by changing the divider resistors 53, 53 or the reference voltage Vos. The position of the protecting switch SW in the circuit may be changed. For example, it may be disposed in the circuit between the voltage booster 2 and the electrical circuit to be powered by the power supply device.

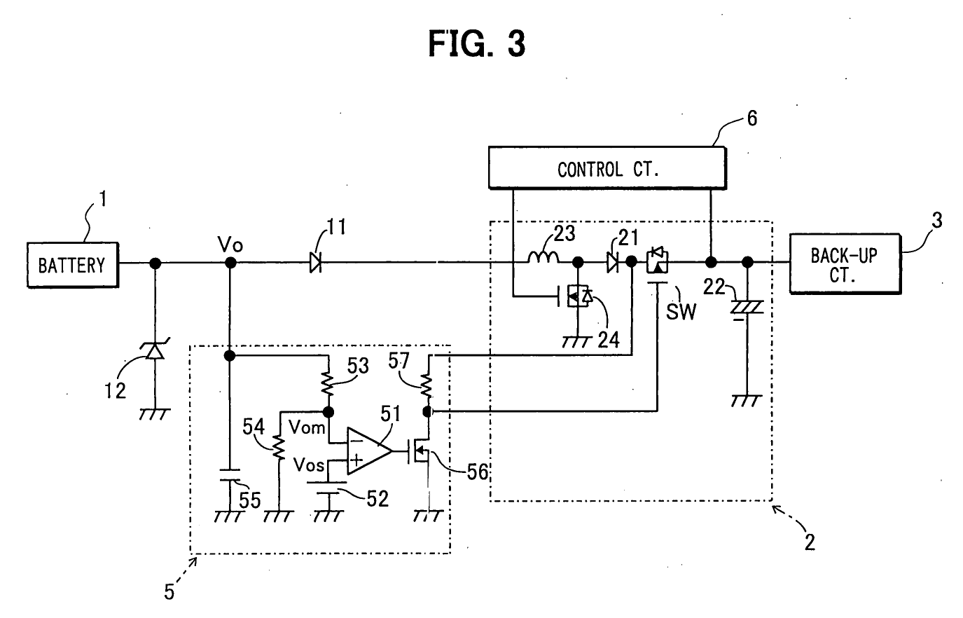

A power supply device as a second embodiment of the present invention is shown in FIG. 3. In this embodiment, only the position of the protecting switch SW in the circuit is changed from that of the first embodiment described above. Other structures and functions are the same as those of the first embodiment. The protecting switch SW is disposed in the voltage booster 2 and positioned between the rectifying diode 21 and the output terminal of the voltage booster 2. The electrical circuit powered by this second embodiment is similarly protected from the overvoltage.

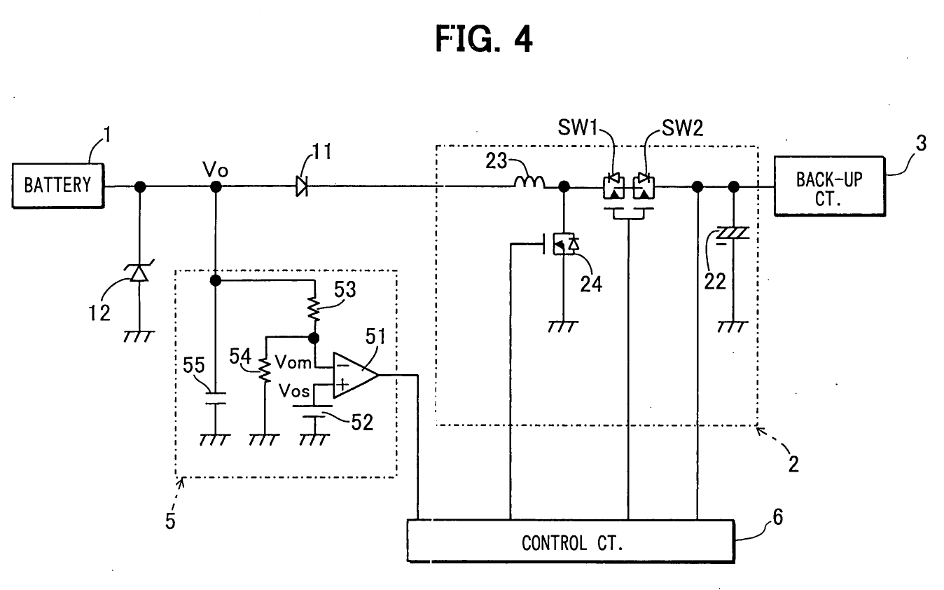

A power supply device as a third embodiment of the present invention is shown in FIG. 4. In this embodiment, the protecting switch SW in the second embodiment is replaced with a pair of protecting switches SW1 and SW2. Each of SW1 and SW2 is composed of an FET, and both are connected so that their parasitic diodes are directed in different directions to each other, as shown in FIG. 4. The pair of protecting switches SW1 and SW2 also functions as the rectifying diode 21. Accordingly, the rectifying diode 21 used in the second embodiment is eliminated in this embodiment. The output signals from the voltage comparator 5 is fed to the control circuit 6, and the pair of protecting switches SW1 and SW2 is controlled by the control circuit 6. When the power source voltage Vo is normal, both of the protecting switches SW1 and SW2 are simultaneously switched, functioning as synchronous rectifying elements. On the other hand, when the power source voltage exceeds a predetermined level, both protecting switches SW1 and SW2 are turned off. In this manner, the back-up circuit 3 connected to the voltage booster 2 and the electrical circuit connected to the back-up circuit 3 are protected from the overvoltage.

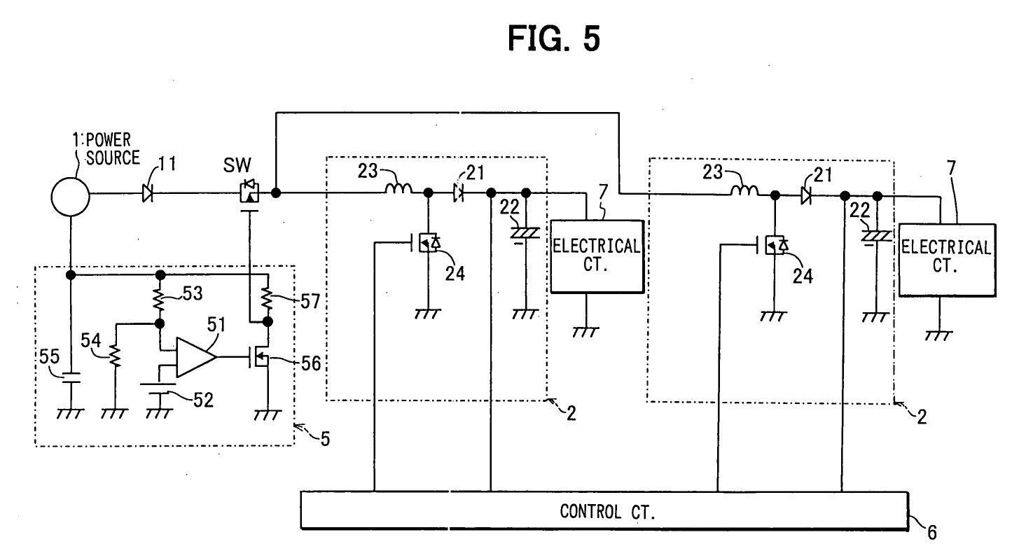

A power supply circuit as a fourth embodiment of the present invention is shown in FIG. 5. In this embodiment, two voltage boosters 2 connected in parallel to each other are connected to the power source 1 through the protecting switch SW. An electrical circuit 7 to which the voltage is supplied from the power source 1 is connected to each voltage booster 2. The protecting switch SW is disposed between the power source 1 and the parallel circuit of two voltage boosters 2. The protecting switch SW is turned off by the voltage comparator 5 when the power source voltage exceeds a predetermined voltage in the same manner as in the foregoing embodiments. Therefore, the electrical circuits 7 are simultaneously protected from the overvoltage by the common protecting switch SW. Though two voltage boosters 2 are connected in parallel in this embodiment, more than two voltage boosters 2 may be connected. Though the protecting switch SW is used commonly to two voltage boosters 2 in this embodiment, it is also possible to use one protecting switch for each voltage booster 2 to keep the protecting switch capacity at a reasonable level.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A power supply device for supplying electric power to an electrical circuit, the power supply device comprising:
a power source;
a voltage comparator connected to the power source for comparing a voltage of the power source with a predetermined reference voltage and for outputting a control signal when the power source voltage is higher than the reference voltage; and
a protecting switch disposed in a circuit between the power source and the electrical circuit, the protecting switch being turned off when the control signal is supplied from the voltage comparator to the protecting switch, thereby protecting the electrical circuit from overvoltage.

2. The power supply device as in claim 1, further comprising a voltage booster for boosting the power source voltage to a predetermined voltage level, the voltage booster being disposed in a circuit connecting the power source and the electrical circuit.

3. The power supply device as in claim 2, wherein:
the protecting switch is disposed between the power source and the voltage booster.

4. The power supply device as in claim 2, wherein:
the protecting switch is disposed in the voltage booster.

5. The power supply device as in claim 2, wherein:
the protecting switch is disposed between the voltage booster and the electrical circuit.

6. The power supply device as in claim 4, wherein:
the voltage booster comprises a booster coil, a booster switch for switching current flowing through the booster coil at a high speed, and a rectifying diode for allowing current to flow only in one direction from the booster coil to the electrical circuit; and
the protecting switch also functions as the rectifying diode.

7. An airbag system for use in an automotive vehicle, the airbag system having an airbag to be inflated with gas upon detection of a collision and an igniting circuit for igniting a device for generating the gas, wherein electrical power is supplied from the power supply device defined in claim 1 to the igniting circuit.
